(19) United States
(12) Patent Application Publication
(10) Pub. No.: US 2010/0117252 A1
(43) Pub. Date: May 13, 2010

(54) SOLID COMPOSITION HAVING ENHANCED PHYSICAL AND ELECTRICAL PROPERTIES

(76) Inventor: John Bourque, Tucson, AZ (US)

Correspondence Address: LEWIS AND ROCA LLP, 1663 Hwy 395, Suite 201, Minden, NV, 89423, US

(21) Appl. No.: 12/613,902

(22) Filed: Nov. 6, 2009

Related U.S. Application Data
(63) Continuation-in-part of application No. 12/268,315, filed on Nov. 10, 2008.

(51) Int. Cl. H01M 4/88; B22D 27/00; C22C 9/00

(52) U.S. Cl. 264/104; 252/182.1; 164/57.1; 420/497

(57) ABSTRACT

A method of making a treating wash includes mixing brass granules with acetone, mixing carbon nanotube material, silver granules, iron pyrite granules and copper granules in the acetone brass mixture, and straining the liquid from the remaining solid material. Methods of treating materials such as brass granules, silver granules, iron pyrite granules, carbon nanotube material, and brass granules comprises washing the materials in the treating wash, followed by straining and drying the materials.

### CROSS-REFERENCE TO RELATED APPLICATIONS

This application is a continuation-in-part of co-pending U.S. patent application Ser. No. 12/268,315, filed Nov. 10, 2008.

### BACKGROUND OF THE INVENTION

1. Field of the Invention

The present invention relates to solid-material compositions having enhanced physical and electrical properties as well as products formed using the material and methods for making the material and the products.

2. The Prior Art

Products such as electrodes, electrode hangers, and bus bars for hydrometallurgy electrowinning (electroextraction) are known in the art. The electrodes are usually made from lead or lead alloys and the electrode hangers and bus bars are usually made from copper.

Body armor is usually formed from a series of plates each comprising a plurality of layers of different materials. Materials such as alloyed ceramics have been successfully employed in body armor plates.

### BRIEF DESCRIPTION

A treating wash according to one aspect of the present invention comprises acetone, brass granules, carbon nanotube material, silver granules, iron pyrite granules, and copper granules. A method of making a treating wash includes mixing brass granules with acetone, mixing silver granules, carbon nanotube material, iron pyrite granules and copper granules in the acetone brass mixture, and straining the liquid from the remaining solid material. Methods of treating materials such as brass granules, iron pyrite granules, carbon nanotube material, and brass granules comprises washing the materials in the treating wash, followed by straining and drying the materials.

According to another aspect of the present invention, a method for forming a lead electrode, comprises providing a batch of molten lead, preparing a wash liquid comprising acetone, brass granules, carbon nanotube material, silver granules, iron pyrite granules, and copper granules, mixed at high speed and strained, treating brass granules with the wash liquid, and straining and drying the brass granules to form treated brass granules, treating iron pyrite granules with the wash liquid, and straining and drying the brass granules to form treated silver granules, iron pyrite granules, treating copper granules with the wash liquid, and straining and drying the brass granules to form treated copper granules, adding the treated brass granules, the treated iron pyrite granules, and the treated copper granules to the molten lead, pouring the molten lead into a pour mold coated with a thin layer of brass granules, allowing the lead to solidify into an ingot and then rolling the ingot in a pressure roller.

According to another aspect of the present invention, a method for forming a copper electrode comprises providing a mold sized for a particular electrode, placing a first layer of treated material in the mold, placing a first layer of acid resistant polymer such as glass-filled nylon in the mold to a height sufficient to cover the first layer of treated material, placing a second layer of treated material in the mold over the first layer of acid resistant polymer, placing a copper plate in the mold over the second layer of treated material, placing a third layer of treated material in the mold over the copper plate, placing a second layer of acid resistant polymer such as glass-filled nylon in the mold to a height sufficient to cover the third layer of treated material, placing a fourth layer of treated material in the mold over the second layer of acid resistant polymer, heating the mold until the polymer begins to melt, removing the mold from the oven, pressing the contents of the mold until a desired thickness is reached, and trimming the electrode to a desired finished size.

According to another aspect of the present invention, a method for forming one of a bus bar and a hanger bar for an electrode comprises providing a length of copper tubing, placing a first plug at a first end of the copper tubing, disposing a copper strip inside the copper tubing, preparing a wash liquid comprising acetone, brass granules, carbon nanotube material, silver granules, iron pyrite granules, and copper granules, mixed at high speed and strained, treating brass granules with the wash liquid, and straining and drying the brass granules to form treated brass granules, treating magnetite with the wash liquid, and straining and drying the brass granules to form treated magnetite, treating silver granules and iron pyrite granules with the wash liquid, and straining and drying the brass granules to form treated iron pyrite granules, treating copper granules with the wash liquid, and straining and drying the brass granules to form treated copper granules, mixing and coating with a penetrating oil the treated brass granules, the treated magnetite, the treated iron pyrite granules, and the treated copper granules to form a fill mixture, filling the copper tubing with the fill mixture; and placing a second plug at a second end of the copper tubing.

According to another aspect of the present invention, a body-armor plate includes a first layer of treated brass granules, a first layer of treated glass-filled polymer, a first layer of treated iron pyrite granules, a metal plate, a second layer of treated iron pyrite granules, a second layer of treated glass-filled polymer, and a second layer of treated brass granules. A method for making a body-armor plate comprises providing a body-armor plate mold, placing a layer of treated brass granules in the body-armor plate mold, placing a layer of treated glass-filled polymer over the layer of treated brass granules, placing a layer of treated iron pyrite over the layer of treated glass-filled polymer, placing a metal plate over the layer of layer of treated iron pyrite, placing a layer of treated iron pyrite over the metal plate; placing a layer of treated glass-filled polymer over the layer of treated iron pyrite, placing a layer of treated brass granules over the layer of glass-filled polymer, placing a cover on the mold, heating the mold and placing the mold in a press.

According to another aspect of the present invention, another body-armor plate includes a first composite layer including a first layer of treated material including a mixture of brass granules, copper granules, and iron pyrite granules, a layer of a treated glass-filled polymer, and a second layer of treated material including brass granules, copper granules, and iron pyrite granules, a first titanium plate, a second composite layer like the first composite layer, a second titanium plate, a third composite layer like the first composite layer, and a steel plate. A method for making the body-armor plate comprises providing a body-armor plate mold, forming a first composite layer by placing a layer of treated material in the body-armor plate mold, placing a layer of treated glass-filled polymer over the layer of treated brass granules, and placing a second layer of treated material over the layer of treated glass-filled polymer, placing a first titanium plate over the first composite layer, forming a second composite layer over the first titanium plate; placing a second titanium plate over the second composite layer, forming a third composite layer over the second titanium plate, placing a steel plate over the third composite layer, placing a cover on the mold, heating the mold and placing the mold in a press.

### BRIEF DESCRIPTION OF THE DRAWING FIGURES

FIG. 1 is a diagram illustrating a process for making a treating wash according to one aspect of the present invention.

FIG. 2 is a diagram illustrating a process for making a calcium-tin lead electrode according to another aspect of the present invention.

FIG. 3 is a diagram illustrating a process for making a copper electrode according to another aspect of the present invention.

FIG. 4 is a diagram showing a radial cross sectional view of an illustrative electrode hanger bar according to another aspect of the present invention.

FIG. 5 is a diagram showing a radial cross sectional view of a second illustrative electrode hanger bar according to another aspect of the present invention.

FIG. 6 is a diagram showing an axial cross sectional view of both the electrode hangars of FIGS. 4 and 5 taken along the line A-A.

FIG. 7 is a diagram illustrating a process for making a hangar bar or bus bar according to another aspect of the present invention.

FIGS. 8A and 8B are diagrams illustrating a body-armor plate according to another aspect of the present invention.

FIG. 9 is a diagram illustrating a process for making the body-armor plate of FIGS. 8A and 8B.

FIGS. 10A and 10B are diagrams illustrating another body-armor plate according to another aspect of the present invention.

FIG. 11 is a flow diagram illustrating a process for making the body-armor plate of FIGS. 10A and 10B.

### DETAILED DESCRIPTION

Persons of ordinary skill in the art will realize that the following description of the present invention is illustrative only and not in any way limiting. Other embodiments of the invention will readily suggest themselves to such skilled persons.

The present invention relates to solid-material compositions having enhanced physical and electrical properties as well as products formed using the material and methods for making the material and the products.

Various products can be made using the composition of the present invention. One aspect of the present invention is a wash or bath used to treat ingredients used to form the composition. Since the volume of the wash or bath will vary with the particular application, an illustrative example is given for formulating the wash using one gallon of acetone. Persons skilled in the art will appreciate that the amounts of the ingredients disclosed in the example can be linearly scaled to formulate larger or smaller batches of the wash.

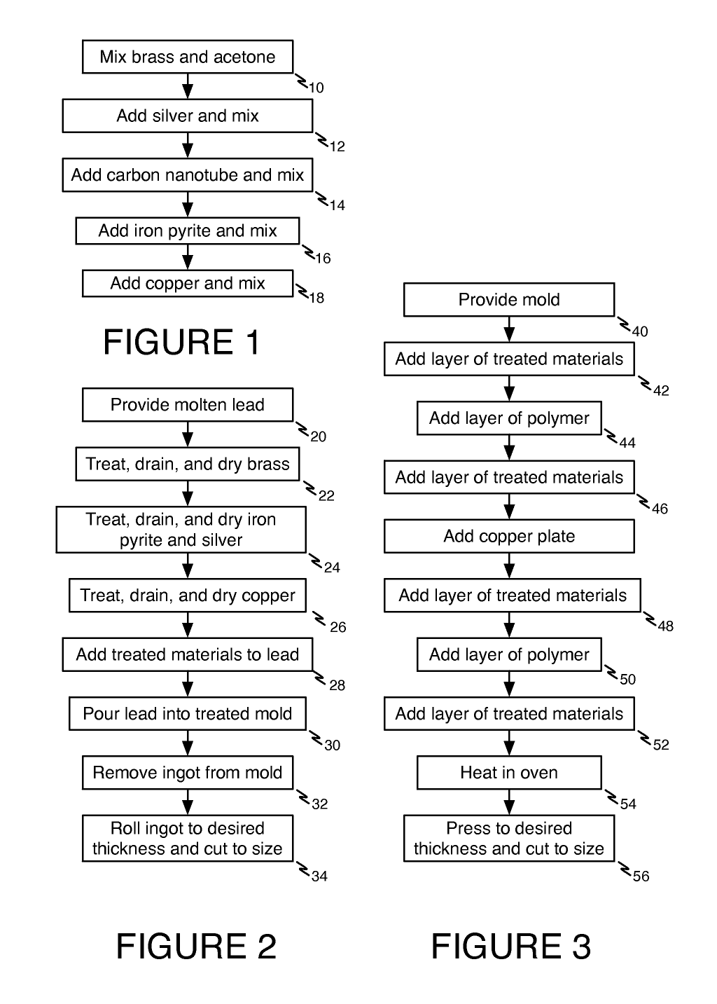

In one illustrative example shown in FIG. 1, at reference numeral 10, brass is mixed with acetone in a commercial blender. In the example, about 454 grams of brass (about 100 mesh or finer) is mixed with one gallon of acetone in a commercial blender at high speed for about 10 minutes or until a gold color appears at the surface of the acetone when the blender is stopped. At reference numeral 12, about 2 grams of silver granules are added and mixed. At reference numeral 14, carbon nanotube material is added and mixed. In the illustrative example, about one gram of multi-walled carbon nanotube material is added and mixed at high speed for about 5 minutes. At reference numeral 16, iron pyrite is added and mixed. In the illustrative example, about 33.5 grams of iron pyrite having a grain size of about 0.125 inch is added and mixed for a minimum of about 3 minutes at high speed. At reference numeral 18, copper is added and mixed. In the illustrative example, about 517 grams of copper (about 100 mesh or finer) is added and mixed at high speed for about 8 minutes until a slurry begins to form on the surface after the blender is turned off. The order in which the carbon nanotube material, the silver, the iron pyrite, and the copper are added is not critical.

When the ingredients have all been mixed as described, the liquid is strained and may be used as a wash or bath. All of the strained solid matter may be stored for further use as disclosed herein. Once materials are processed, the wash liquid used may be collected and recycled by adding it to new batches of the wash liquid.

Once the wash liquid is formulated, constituent materials of products to be fabricated are washed using it. A sticky film merges with the constituent materials. The constituent materials are bonded together by drying and application of pressure, either in an oven or at room temperature.

According to one aspect of the present invention, the composition is usefully employed in fabricating calcium-tin lead anode and cathode electrodes for hydrometallurgy electrowinning (electroextraction) processing applications such as refining processes performed in the mining industry and batteries. According to one example of a process for forming an anode described with reference to FIG. 2, at reference numeral 20, a batch of lead is melted. In the illustrative example, about 635 Kg of molten lead containing appropriate amounts of calcium and tin as is known in the art is provided in a suitable vessel at a temperature of about 800° F. At reference numeral 22, brass is treated with the wash liquid disclosed above. In the illustrative example, about 9 Kg of brass granules (about 100 mesh) are treated with the wash described above by running it over the granules. The wash liquid is drained off and the treated brass granules are allowed to dry. At reference numeral 24, about 2.3 Kg of powdered iron pyrite (about 0.025 inch granules), along with about 2 ounces of powdered silver (about 100 mesh) are treated with the wash liquid. At reference numeral 26, copper is treated with the wash liquid. In the illustrative example, about 4.5 Kg of copper granules (about 100 mesh) are treated as above and allowed to dry. At reference numeral 28, the treated brass, iron pyrite, and copper are added to the molten lead. A mold in the desired shape of the anode is provided. A thin layer of about 100 mesh brass is evenly sprinkled on the full bottom of the lead pour mold plate, this allows the material to flow evenly from top to bottom as the lead is being poured and is cooling.

The bottom of the mold is lined with a mixture of the treated materials and the lead is then poured into the mold at reference numeral 30. As the treated-lead anode ingot is being cooled, it is removed from the mold at reference numeral 32 and transported to a rolling press where, at reference numeral 34, it is rolled to a desired thickness such as about 0.25 inches and cut to size into finished anodes having desired dimensions such as about 3 ft. by about 4 ft. by about 0.25 inches.

Anodes formed in accordance with the present invention are more conductive than conventional lead anodes. It is believed that these anodes will last longer than conventional anodes.

Referring now to FIG. 3, a method for forming a copper electrode according to another aspect of the present invention comprises providing a mold sized for a particular electrode, placing a first layer of treated material in the mold, placing a first layer of acid resistant polymer such as glass-filled nylon in the mold to a height sufficient to cover the first layer of treated material, placing a second layer of treated material in the mold over the first layer of acid resistant polymer, placing a copper plate in the mold over the second layer of treated material, placing a third layer of treated material in the mold over the copper plate, placing a second layer of acid resistant polymer such as glass-filled nylon in the mold to a height sufficient to cover the third layer of treated material, placing a fourth layer of treated material in the mold over the second layer of acid resistant polymer, heating the mold at about 800° F. for about 30 minutes or until the polymer begins to melt, removing the mold from the oven, pressing the contents of the mold until a desired thickness is reached, and trimming the electrode to a desired finished size.

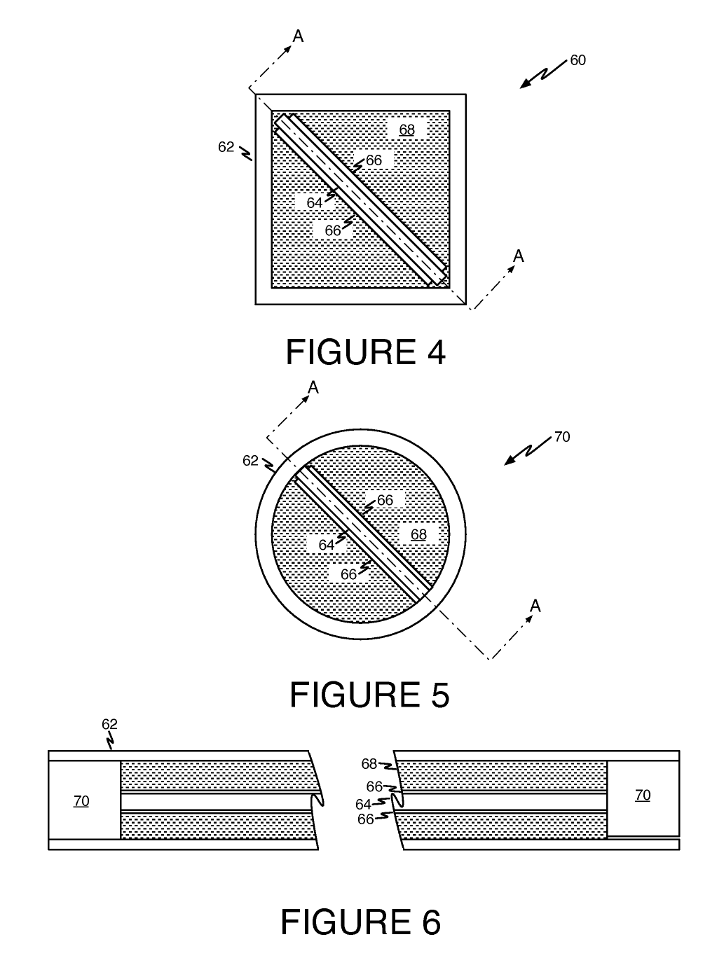

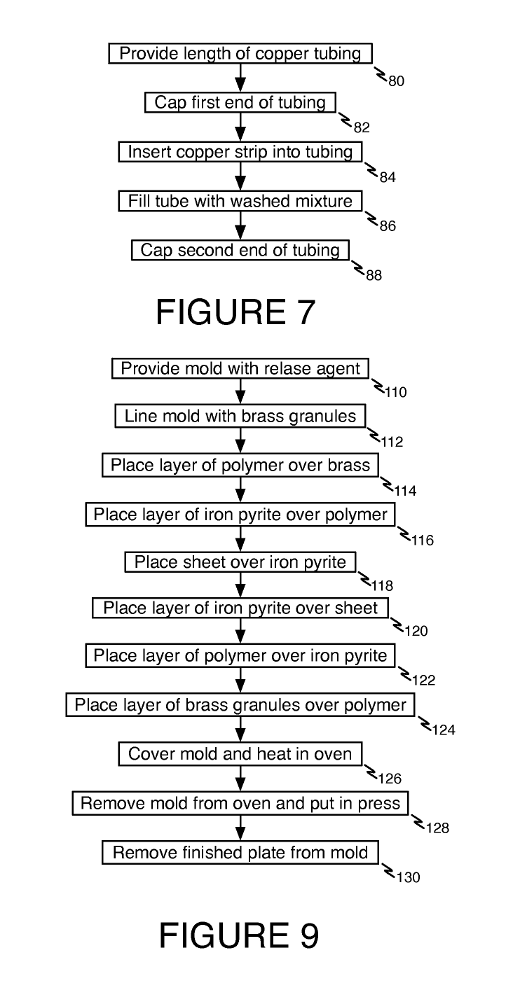

According to another aspect of the present invention, the composition is usefully employed in hanger bars used to support and supply current to anodes and cathodes. Different views of two illustrative examples of hanger bars according to the present invention are shown in FIGS. 4, 5, and 6. A process for fabricating the hangar bar is illustrated in FIG. 7. According to one illustrative embodiment of a hanger bar 60 according to the present invention, a suitable length of copper tubing 62 having, for example, a rectangular cross section as shown in FIG. 4 or a circular cross section as shown in FIG. 5, is provided at reference numeral 80 of FIG. 7. In one illustrative embodiment, the rectangular tubing may have wall dimensions of, for example, about 1.75 inches by 0.75 inches and a wall thickness of about 0.125 inches. As will be appreciated by persons of ordinary skill in the art, the wall thickness may be selected as a function of the weight of the electrode to be supported. At reference numeral 82, one end of the tube is capped and at reference numeral 84 of FIG. 7, a copper strip 64 shown in FIGS. 4-6 having a length smaller than the length of the copper tubing by twice the length of a copper plug that will be used to seal the hanger bar and having a width selected to provide a slip fit into the tubing is placed inside the copper tubing. Preferably, perforated steel strips 66 shown in FIGS. 4-6 are affixed to one or both faces of the copper strip 44 by, for example, spot welding, soldering, or brazing prior to inserting the strip into the tubing. At reference numeral 86, the tube is filled with a mixture of brass, multi-walled carbon nanotube material, iron pyrite, and copper as described above and shown at reference numeral 68.

Plugs 70, shown in FIG. 6 and formed from a material such as copper, are used to seal the tubing and may be held in place by, for example, press fitting, welding, brazing or soldering. A copper plug 70 having a length of about 2 inches has been found to be satisfactory for this purpose although other lengths could be employed.

Prior to filling the tubing, the mixture of brass, iron pyrite, and copper 68 as described above is washed using the acetone solution and drained as described above. Additionally, about 2 gms of magnetite washed and drained using the acetone solution is added to the mixture. The drained mixture is coated with penetrating oils such as oils sold under the trademark WD-40 and is then packed into the tubing around the inserted strip. At reference numeral 88 of FIG. 7, a second plug 70 is inserted into the other end of the tubing and may be held in place by, for example, press fitting, welding, brazing or soldering.

According to another aspect of the present invention, a bus bar may be formed using the same process used to form the hanger bar. A center copper strip 64 is sandwiched between perforated steel sheets 66 and is disposed in a suitable length of copper tubing 62 as previously shown in FIGS. 4, 5, and 6. A mixture of copper, brass iron pyrite, and magnetite (reference numeral 68) treated as described herein is poured into the tubing, which is then capped with a plug 70 on each end. The length of a bus bar can and does very from application to application, the particular length chosen to fit the application. One advantage of using such a bus bar is to provide a more conductive lead to both the anode and cathode, thus providing more current and less voltage drop to the cell.

According to another aspect of the present invention, electrodes including anodes and cathodes for zinc hydrometallurgy electrowinning (electroextraction) processes is formed using substantially the same mixing process as used for the copper anode with only one exception. That exception is the substitution of substantially equal amounts of additional brass and iron pyrite in place of the copper at reference numeral 26 in the process illustrated in FIG. 2. The brass should be high in zinc not copper; a brass composition having by weight about 68.5% copper, about 1.5% lead, and about 30% zinc has been found to be suitable for this application. The zinc hydrometallurgy electrode is made using the same process shown in FIG. 2 used to form the lead electrode, except that about 0.46% silver is substituted for the calcium-tin and the modified mixture containing the additional brass and iron pyrite is used in place of the copper.

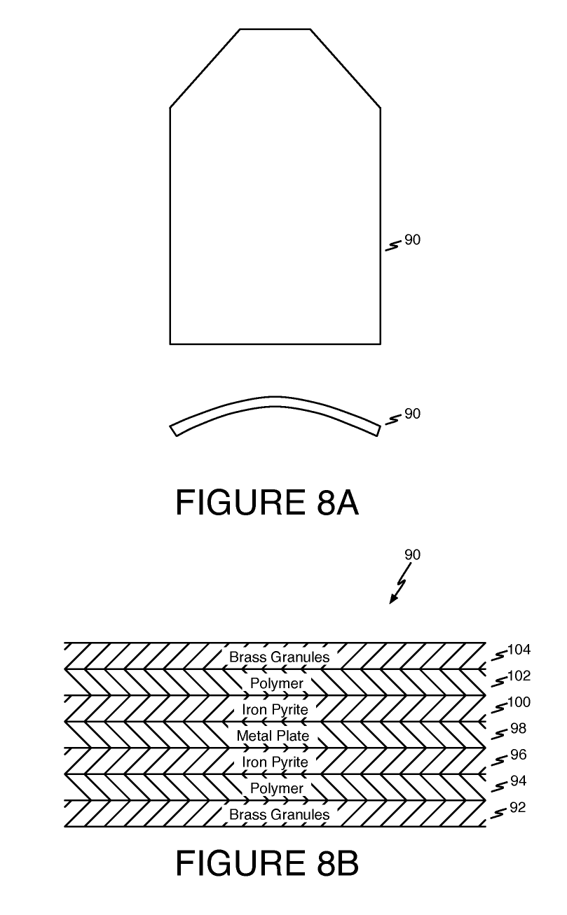

Referring now to FIGS. 8A and 8B, the composition is usefully employed to form a plate 90 that may be used in body armor according to another aspect of the present invention. FIG. 8A shows both a front and an illustrative bottom view of a body armor plate according to the present invention. While the illustrative bottom view shown in FIG. 8A indicates that plate 90 is curved, persons of ordinary skill in the art will appreciate that plate 90 could be flat, depending on the application.

Referring now to FIG. 8B, a cross-sectional view of plate 90 is shown. Body-armor plate 90 includes a first layer 92 of treated brass granules, a first layer 94 of treated glass-filled polymer, a first layer 96 of treated iron pyrite granules, a metal plate 98, a second layer 100 of treated iron pyrite granules, a second layer 102 of treated glass-filled polymer, and a second layer 104 of treated brass granules.

Referring now to FIG. 9, according to one example of a process for fabricating body armor according to the present invention, a mold for an armor plate is provided. At reference numeral 110, the mold is sprayed with a mold release agent. At reference numeral 112, the top and bottom mold plates are completely covered with brass powder (about 100 mesh). A depth of about 0.03125 inch has been found to be satisfactory. At reference numeral 114, a layer of glass-filled nylon polymer is washed using the wash liquid and is placed over the brass granules. A depth of about 0.125 inch has been found to be satisfactory. At reference numeral 116, a layer of iron pyrite is placed over the glass-filled polymer. A depth of about 0.125 inch has been found to be satisfactory. At reference numeral 118, a plate formed from a material such as titanium (for example about 0.125 inch thick) or carbon steel (about 0.0625 inch thick) is placed above the pyrite layer. The process is then reversed, and at reference numeral 120, a layer of iron pyrite is placed over the plate. A depth of about 0.125 inch has been found to be satisfactory. At reference numeral 122, a layer of glass-filled nylon polymer washed using the wash liquid is placed over the layer of iron pyrite. A depth of about 0.125 inch has been found to be satisfactory. At reference numeral 124, a layer of brass granules (about 100 mesh or finer) is placed over the layer of glass-filled nylon polymer. A depth of about 0.0625 inch has been found to be satisfactory.

At reference numeral 126, a cover is placed on the mold and the mold is placed in an oven at a temperature of, for example, 800° F. for an interval of about 15 minutes, or until the glass-filled nylon polymer begins to melt. At reference numeral 128, the mold is then removed from the oven and immediately placed in a press rated about 50-100 tons where the mold cover is uniformly pressed into the mold until the material cools to a temperature of about 140° F. At reference numeral 130, the finished plate is then released from the mold.

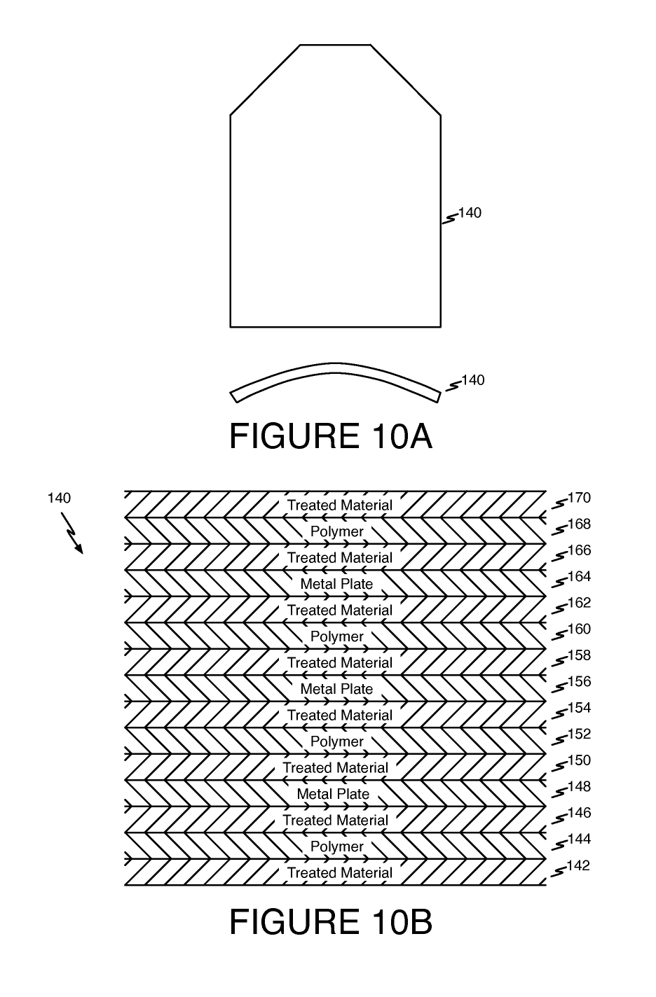

Referring now to FIGS. 10A and 10B, the composition is usefully employed to form a plate 140 that may be used in body armor according to another aspect of the present invention. FIG. 8A shows both a front and an illustrative bottom view of a body-armor plate according to the present invention. While the illustrative bottom view shown in FIG. 8A indicates that body-armor plate 140 is curved, persons of ordinary skill in the art will appreciate that body-armor plate 140 could be flat, depending on the application.

Referring now to FIG. 10B, a cross-sectional view of plate 140 is shown. Body-armor plate 140 includes plate includes a first composite layer including a layer of treated material 142 including a mixture of brass granules, copper granules, and iron pyrite granules, a second layer 144 of a treated glass-filled polymer, and a second layer 146 of treated material including brass granules, copper granules, and iron pyrite granules, a first titanium plate 148, a second composite layer like the first composite layer including a first layer 150 of treated material including a mixture of brass granules, copper granules, and iron pyrite granules, a layer 152 of a treated glass-filled polymer, and a second layer 154 of treated material including brass granules, copper granules, and iron pyrite granules, a second titanium plate 156, a third composite layer like the first composite layer including a first layer 158 of treated material including a mixture of brass granules, copper granules, and iron pyrite granules, a layer 160 of a treated glass-filled polymer, and a second layer 162 of treated material including brass granules, copper granules, and iron pyrite granules, a steel plate 164, and a fourth composite layer like the first composite layer including a first layer 166 of treated material including a mixture of brass granules, copper granules, and iron pyrite granules, a layer 168 of a treated glass-filled polymer, and a second layer 170 of treated material including brass granules, copper granules, and iron pyrite granules.

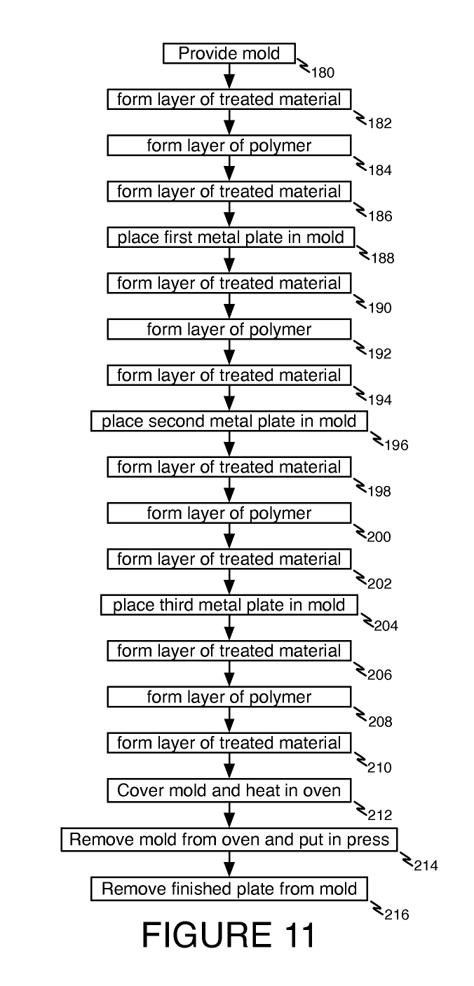

Referring now to FIG. 11, a flow diagram illustrates a method for making the body-armor plate of FIGS. 10A and 10B. The method comprises first, at reference numeral 180 providing a body-armor plate mold having a desired contour shape (e.g., either flat or curved). At reference numeral 182, a layer of treated material according to the present invention is placed in the body-armor plate mold to a depth sufficient to just cover the surface of the mold. Next, at reference numeral 184, a layer of treated glass-filled polymer is formed over the layer of treated brass granules to a depth of, for example 0.125 inch. Next, at reference numeral 186, a second layer of treated material is formed to a depth of, for example, 0.125 inch over the layer of treated glass-filled polymer. Next, at reference numeral 188, a first metal plate, which may be, for example, a titanium plate having a thickness of about 0.125 inch, is placed over the layer of treated material.

At reference numeral 190, a layer of treated material according to the present invention is placed in the body-armor plate mold over the first metal plate. Next, at reference numeral 192, a layer of treated glass-filled polymer is formed over the layer of treated brass granules to a depth of, for example 0.125 inch. Next, at reference numeral 194, a second layer of treated material is formed to a depth of, for example, 0.125 inch over the layer of treated glass-filled polymer. Next, at reference numeral 196, a second metal plate, which may be, for example, a titanium plate having a thickness of about 0.125 inch, is placed over the layer of treated material.

At reference numeral 198, a layer of treated material according to the present invention is placed in the body-armor plate mold over the first metal plate. Next, at reference numeral 200, a layer of treated glass-filled polymer is formed over the layer of treated brass granules to a depth of, for example 0.125 inch. Next, at reference numeral 202, a second layer of treated material is formed to a depth of, for example, 0.125 inch over the layer of treated glass-filled polymer. Next, at reference numeral 204, a second metal plate, which may be, for example, a 16-guage steel plate is placed over the layer of treated material.

At reference numeral 206, a layer of treated material according to the present invention is placed in the body-armor plate mold over the first metal plate. Next, at reference numeral 208, a layer of treated glass-filled polymer is formed over the layer of treated brass granules to a depth of, for example 0.125 inch. Next, at reference numeral 210, a second layer of treated material is formed to a depth of, for example, 0.125 inch over the layer of treated glass-filled polymer.

Next, at reference numeral 212 a cover is placed on the mold, and the mold is placed in an oven and heated at a temperature of, for example, about 800° F. until the polymer begins to soften and melt. At reference numeral 214 the mold is then removed from the oven and immediately placed in a press rated about 50-100 tons where the mold cover is uniformly pressed into the mold until the material cools to a temperature of about 140° F. At reference numeral 216, the finished body-armor plate is removed from the mold and edge trimmed if necessary.

According to another aspect of the present invention, a copper alloy is disclosed. For a total weight of about 1 Kg, about 50 grams of treated material and about 10 grams of silver powder is melted into about 960 grams of copper. For making wire, a known copper wire mix may be used, a non-limiting example of which is disclosed in ASTM Int'l, ASTM B 49-08a, Standard Specification for Copper Rod Drawing Stock for Electrical Purposes, Table 1. The alloy is formed into wire drawing rods for drawing wire. For other applications, the alloy is formed into ingots from which other products, such as electrical connectors and other products, may be formed.

According to another aspect of the present invention, an aluminum alloy is disclosed. For a total weight of about 1 Kg, about 130 grams of treated material and about 10 grams of silver powder is melted into about 860 grams of aluminum. The alloy is formed into wire drawing rods for drawing wire. For other applications, the alloy is formed into ingots from which other products may be formed.

While embodiments and applications of this invention have been shown and described, it would be apparent to those skilled in the art that many more modifications than mentioned above are possible without departing from the inventive concepts herein. The invention, therefore, is not to be restricted except in the spirit of the appended claims.

What is claimed is:

1. A treating wash comprising acetone, brass granules, carbon nanotube material, silver granules, iron pyrite granules, and copper granules.

2. The treating wash of claim 1 comprising about 454 grams of brass, about one gram of multi-walled carbon nanotube material, 10 grams of silver, about 33.5 grams of iron pyrite, and about 517 grams of copper per gallon of acetone.

3. The treating wash of claim 1 wherein the brass granules are about 100 mesh or finer, the silver is 100 mesh or finer, the iron pyrite has a grain size of about 0.125 inch, and the copper granules are about 100 mesh or finer.

4. A method of making a treating wash comprising:
mixing brass granules with acetone;
Mixing carbon nanotube material, silver granules, iron pyrite granules and copper granules in the acetone brass mixture; and
straining the liquid from the remaining solid material.

5. The method of claim 4 further comprising storing the strained solid material.

6. The method of claim 4 wherein:
mixing brass granules with acetone comprises mixing about 454 grams of brass (about 100 mesh or finer) per gallon of acetone in a commercial blender at high speed for about 10 minutes or until a gold color appears at the surface of the acetone when the blender is stopped;
mixing carbon nanotube material comprises mixing about one gram of multi-walled carbon nanotube material per gallon of acetone at high speed for about 5 minutes;
mixing iron pyrite comprises mixing about 33.5 grams of iron pyrite per gallon of acetone, the iron pyrite having an average grain size of about 0.125 inch for a minimum of about 3 minutes at high speed;
mixing silver comprises mixing about 10 grams of silver granules at about 100 mesh or finer about 3 minutes a high speed; and
mixing copper comprises mixing about 517 grams of copper per gallon of acetone, the copper having a mesh size of about 100 mesh or finer for about 8 minutes until a slurry begins to form on the surface after the blender is turned off.

7. The method of claim 6 further comprising storing the strained solid material.

8. A method for forming a lead electrode, comprising:
providing a batch of molten lead;
preparing a wash liquid comprising acetone, brass granules, carbon nanotube material, silver granules, iron pyrite granules, and copper granules, mixed at high speed and strained;
treating brass granules with the wash liquid, and straining and drying the brass granules to form treated brass granules;
treating iron pyrite granules with the wash liquid, and straining and drying the iron pyrite granules to form treated iron pyrite granules;
treating silver granules with the wash liquid, and straining and drying the silver granules to form treated silver granules;
treating copper granules with the wash liquid, and straining and drying the brass granules to form treated copper granules;
adding the treated brass granules, the treated silver granules, the treated iron pyrite granules, and the treated copper granules to the molten lead;
pouring the molten lead into a pour mold coated with a thin layer of brass granules;
allowing the lead to solidify into an ingot and then rolling the ingot in a pressure roller.

9. The method of claim 8 wherein:
providing a batch of molten lead comprises providing about 635 Kg of molten lead;
preparing a wash liquid comprising acetone, brass granules, carbon nanotube material, silver granules, iron pyrite granules, and copper granules, mixed at high speed and strained;
treating brass granules comprises treating about 9 Kg of brass granules having a size of about 100 mesh or finer for each about 635 Kg of molten lead;
treating iron pyrite granules comprises treating about 2.3 Kg of powdered iron pyrite having a size of about 0.025 inch or finer for each about 635 Kg of molten lead;
treating silver granules comprises treating about 56 grams of silver granules 100 mesh or finer along with; and
treating copper granules comprises treating about 4.5 Kg of copper granules having a size of about 100 mesh or finer for each about 635 Kg of molten lead.

10. The method of claim 9 wherein preparing the wash liquid comprises:
mixing brass granules with acetone;
mixing brass granules, silver granules, iron pyrite granules and copper granules in the acetone brass mixture; and
straining the liquid from the remaining solid material.

11. The method of claim 10 wherein:
mixing brass granules with acetone comprises mixing about 454 grams of brass (about 100 mesh or finer) per gallon of acetone in a commercial blender at high speed for about 10 minutes or until a gold color appears at the surface of the acetone when the blender is stopped;
mixing carbon nanotube material comprises mixing about one gram of multi-walled carbon nanotube material per gallon of acetone at high speed for about 5 minutes;
mixing iron pyrite comprises mixing about 33.5 grams of iron pyrite per gallon of acetone, the iron pyrite having an average grain size of about 0.125 inch for a minimum of about 3 minutes at high speed;
mixing silver granules comprises mixing about 10 grams of silver granules 100 mesh or finer for about 3 minutes at high speed; and
mixing copper comprises mixing about 517 grams of copper per gallon of acetone, the copper having a mesh size of about 100 mesh or finer for about 8 minutes until a slurry begins to form on the surface after the blender is turned off.

12. The method of claim 8 wherein rolling the ingot in a pressure roller comprises rolling the ingot in a pressure roller as it is cooling.

13. The method of claim 8 wherein rolling the ingot in a pressure roller comprises rolling the ingot to a thickness of about 0.25 inches.

14. The method of claim 8 further including cutting the ingot to a finished size.

15. The method of claim 14 wherein the finished size is about 3 ft. by about 4 ft.

16. The method of claim 8 wherein providing a batch of molten lead comprises providing a molten calcium-tin lead composition.

17. A method for forming one of a bus bar and a hanger bar for an electrode comprising:
providing a length of copper tubing;
placing a first plug at a first end of the copper tubing;
disposing a copper strip inside the copper tubing;
preparing a wash liquid comprising acetone, brass granules, carbon nanotube material, iron pyrite granules, and copper granules, mixed at high speed and strained;
treating brass granules with the wash liquid, and straining and drying the brass granules to form treated brass granules;
treating magnetite with the wash liquid, and straining and drying the brass granules to form treated magnetite;
treating iron pyrite granules with the wash liquid, and straining and drying the iron pyrite granules to form treated iron pyrite granules;
treating silver granules with the wash liquid, and straining and drying the silver granules to form treated silver granules;
treating copper granules with the wash liquid, and straining and drying the brass granules to form treated copper granules;
mixing and coating with a penetrating oil the treated brass granules, the treated magnetite, the treated iron pyrite granules, and the treated copper granules to the molten lead to form a fill mixture;
filling the copper tubing with the fill mixture; and
placing a second plug at a second end of the copper tubing.

18. The method of claim 17 wherein disposing a copper strip inside the copper tubing comprises disposing a copper strip sandwiched between two steel strips inside the copper tubing.

19. A method for forming a lead electrode, comprising:
providing a batch of molten lead including molten silver;
preparing a wash liquid comprising acetone, brass granules, carbon nanotube material, silver granules, iron pyrite granules, and copper granules, mixed at high speed and strained;
treating brass granules with the wash liquid, and straining and drying the brass granules to form treated brass granules;
treating iron pyrite granules with the wash liquid, and straining and drying the iron pyrite granules to form with treated silver and iron pyrite granules;
treating silver granules with the wash liquid, and straining and drying the silver granules to form treated silver granules;
adding the treated brass granules, and the treated silver granules, iron pyrite granules to the molten lead;
pouring the molten lead into a pour mold coated with a thin layer of brass granules; and
allowing the lead to solidify into an ingot and then rolling the ingot in a pressure roller.

20. The method of claim 19 wherein:
providing a batch of molten lead comprises providing about 635 Kg of molten lead;
preparing a wash liquid comprising acetone, brass granules, carbon nanotube material, silver granules, iron pyrite granules, and copper granules, mixed at high speed and strained;
treating brass granules comprises treating about 11.25 Kg of brass granules having a size of about 100 mesh or finer for each about 635 Kg of molten lead;
treating iron pyrite granules comprises treating about 4.55 Kg of powdered iron pyrite having a size of about 0.025 inch or finer for each about 635 Kg of molten lead; and
treating silver granules comprises treating about 56 grams of silver granules having a size of about 100 mesh or finer for each about 635 Kg of molten lead.

21. The method of claim 19 wherein providing a batch of molten lead including molten silver comprises providing a batch of molten lead including about 0.46% molten silver by weight.

22. The method of claim 20 wherein preparing the wash liquid comprises:
mixing brass granules with acetone;
mixing iron pyrite granules in the acetone brass mixture;
mixing silver granules in the acetone brass mixture; and
straining the liquid from the remaining solid material.

23. The method of claim 22 wherein:
mixing brass granules with acetone comprises mixing about 454 grams of brass (about 100 mesh or finer) per gallon of acetone in a commercial blender at high speed for about 10 minutes or until a gold color appears at the surface of the acetone when the blender is stopped;
mixing carbon nanotube material comprises mixing about one gram of multi-walled carbon nanotube material per gallon of acetone at high speed for about 5 minutes;
mixing iron pyrite comprises mixing about 33.5 grams of iron pyrite per gallon of acetone, the iron pyrite having an average grain size of about 0.125 inch for a minimum of about 3 minutes at high speed; and
mixing silver comprises mixing about 10 grams of silver granules 100 mesh or finer for about 3 minutes at high speed.

24. The method of claim 19 wherein rolling the ingot in a pressure roller comprises rolling the ingot in a pressure roller as it is cooling.

25. The method of claim 19 wherein rolling the ingot in a pressure roller comprises rolling the ingot to a thickness of about 0.25 inches.

26. The method of claim 19 further including cutting the ingot to a finished size.

27. The method of claim 26 wherein the finished size is about 3 ft. by about 4 ft.

28. A method for making a body-armor plate comprising:
providing a body-armor plate mold;
placing a first layer of treated material in the body-armor plate mold;
placing a first layer of glass-filled polymer over the first layer of treated material;
placing a second layer of treated material over the first layer of glass-filled polymer;
placing a first metal plate over the second layer of layer of treated material;
placing a third layer of treated material over the first metal plate;
placing a second layer of glass-filled polymer over the third layer of treated material;
placing a fourth layer of treated material over the second layer of glass-filled polymer;
placing a second metal plate over the fourth layer of layer of treated material;
placing a fifth layer of treated material over the second metal plate;
placing a third layer of glass-filled polymer over the fifth layer of treated material;
placing a sixth layer of treated material over the third layer of glass-filled polymer;
placing a third metal plate over the sixth layer of layer of treated material;
placing a seventh layer of treated material over the third metal plate;
placing a fourth layer of glass-filled polymer over the seventh layer of treated material;
placing a eighth layer of treated material over the fourth layer of glass-filled polymer;
placing a cover on the mold;
heating the mold; and
placing the mold in a press.

29. The method of claim 28 further including:
preparing a wash liquid comprising acetone, brass granules, carbon nanotube material, silver granules, iron pyrite granules, and copper granules, mixed at high speed and strained;
treating brass granules with the wash liquid, and straining and drying the brass granules to form treated brass granules;
treating brass granules with the wash liquid, and straining and drying the brass granules to form treated brass granules;
treating glass-filled polymer granules with the wash liquid, and straining and drying the brass granules to form treated glass-filled polymer granules; and
treating iron pyrite granules with the wash liquid, and straining and drying the iron pyrite granules to form treated iron pyrite granules.

30. The method of claim 29 wherein placing each of the first through eighth layers of treated material in the body-armor plate mold comprises placing a layer of treated to a depth of about 0.0125 inches in the mold.

31. The method of claim 29 wherein placing each of the first through fourth layers of treated glass-filled polymer over the layer of brass granules comprises placing a layer of treated glass-filled polymer to a depth of about 0.125 inch.

32. The method of claim 29 wherein each of the first and second metal plate is a plate formed from one of titanium having a thickness of about 0.125 inch and carbon steel having a thickness of about 0.0625 inch.

33. The method of claim 29 wherein placing a third metal plate over the sixth layer of layer of treated material comprises placing a steel plate over the sixth layer of layer of treated material.

34. The method of claim 29 wherein heating the mold comprises heating the mold until the glass-filled nylon polymer begins to melt.

35. The method of claim 29 wherein placing the mold in a press comprises in placing the mold in a press rated about 50-100 tons and uniformly pressing the mold cover into the mold until the material cools to a temperature of about 140° F.

36. A copper alloy comprising per kilogram:
about 960 grams of copper;
about 50 grams of treated material; and
about 10 grams of silver;

37. The alloy of claim 36 wherein the copper is a wire mix.

38. An aluminum alloy comprising per kilogram:
about 860 grams of aluminum;
about 130 grams of treated material; and
about 10 grams of silver.
